(19) United States
(12) Patent Application Publication
(10) Pub. No.: US 2012/0213226 A1
(43) Pub. Date: Aug. 23, 2012

(54) PROCESSING DATA PACKET TRAFFIC IN A DISTRIBUTED ROUTER ARCHITECTURE

(75) Inventors: Nirmesh Patel, Kanata (CA); Daniel Lafleur, Kanata (CA)

(73) Assignee: ALCATEL-LUCENT CANADA INC., Ottawa (CA)

(21) Appl. No.: 13/033,321

(22) Filed: Feb. 23, 2011

(51) Int. Cl. H04L 12/56

(52) U.S. Cl. 370/392

(57) ABSTRACT

Embodiments of the invention are directed to efficiently processing packet traffic in a system such as a switch or router having a distributed architecture. An internal header is appended to an ingress packet by an ingress packet processing device before the packet is forwarded to a fabric switch of the system. The internal header corresponds to a configuration of an ingress interface over which the packet was received. An egress packet processing device, upon receiving the packet from the switch, processes the packet based on the internal header and a configuration of an egress interface associated with the egress device. Advantageously, some packet tag manipulation operations are performed only at the egress packet processing device; thereby somewhat freeing up ingress packet processing resources.

### FIELD OF THE INVENTION

The invention is directed to processing data packet traffic in a communications system such as a switch or router having a distributed architecture.

### BACKGROUND OF THE INVENTION

On communication system interfaces that support Ethernet encapsulation, an 802.1Q Virtual Local Area Network (VLAN) tag of an incoming Ethernet frame needs to be manipulated based on the configuration of an ingress interface that receives the frame. Also before the Ethernet frames leaves an egress interface, the 802.1Q VLAN tag of the Ethernet frame needs to be manipulated again according to the encapsulation configured on the egress interface. For example: when an Ethernet frame with 802.1Q VLAN tag is received over an ingress interface configured with 802.Q VLAN encapsulation, the 802.1Q VLAN tag is typically removed from the Ethernet frame prior to switching the frame via a switching fabric of the system. Before the switched Ethernet frame leaves an egress interface configured with 802.1Q VLAN encapsulation, an 802.1Q VLAN tag is added to Ethernet frame. Processing the Ethernet frame in this manner means the frame's encapsulation is manipulated twice: first when the frame is received on the ingress interface and second before the frame leaves the egress interface.

Processing Ethernet frames, in general data packets, consumes considerable resources of a data communication system, particularly network processors and the like as well as other associated packet processing resources. Therefore, an efficient way of processing packets in a data communication system such as a switch or router having a distributed architecture is desired.

### SUMMARY

According to an aspect of the invention a method of processing a packet in a system in provided. The method comprises the steps of: receiving the packet at an ingress interface of the system; adding an internal header to the packet, the internal header corresponding to a configuration of the ingress interface; switching the packet with the internal header to a device of the system; determining a configuration of an egress interface associated with the device; and processing the packet based on the internal header and the configuration of the egress interface.

According to another aspect of the invention a method of processing an Ethernet packet in a system is provided. The method comprises the steps of: receiving the Ethernet packet at an ingress interface of the system; adding an internal header to the Ethernet packet, the internal header corresponding to an ingress configuration of the ingress interface; switching the Ethernet packet with the internal header to a device of the system; determining an egress configuration of an egress interface associated with the device; determining from the internal header if the ingress configuration is of a first type; removing the internal header from the Ethernet packet; removing a first VLAN tag from the Ethernet packet if the egress configuration is not of the first type and the ingress configuration is of the first type; inserting into the Ethernet packet a second VLAN tag corresponding to the egress configuration if the egress configuration is of the first type and the ingress configuration is not of the first type; and removing the first VLAN tag from the Ethernet packet and inserting the second VLAN tag into the Ethernet packet if the egress configuration and the ingress configuration are of the first type.

According to yet another aspect of the invention an apparatus for processing a packet is provided. The apparatus comprises: an ingress device having access to ingress configuration for receiving packets and being operable to receive the packet and add thereto an internal header corresponding to the ingress configuration; an egress device having access to egress configuration for transmitting packets; and a switch operable to receive from the ingress device and transmit to the egress device the packet with the internal header, wherein the egress device is operable to process the packet based on the internal header and the egress configuration.

According to still another aspect of the invention an apparatus for processing an Ethernet packet is provided. The apparatus comprises: an ingress device having an ingress configuration for receiving packets and being operable to receive the Ethernet packet and add thereto an internal header corresponding to the ingress configuration; an egress device having an egress configuration for transmitting packets; and a switch operable to receive from the ingress device and transmit to the egress device the Ethernet packet with the internal header. The egress device is further operable to: determine from the internal header if the ingress configuration is 802.1Q VLAN encapsulation; remove the internal header from the Ethernet packet; remove a first VLAN tag from the Ethernet packet if the egress configuration is not 802.1Q VLAN encapsulation and the ingress configuration is 802.1Q VLAN encapsulation; insert into the Ethernet packet a second VLAN tag corresponding to the egress configuration if the egress configuration is 802.1Q VLAN encapsulation and the ingress configuration is not 802.1Q VLAN encapsulation; and remove the first VLAN tag from the Ethernet packet and insert the second VLAN tag into the Ethernet packet if the egress configuration and the ingress configuration are 802.1Q VLAN encapsulation.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 depicts an apparatus for processing Ethernet VLAN traffic in a distributed router architecture according to a first embodiment of the invention.

FIG. 2 depicts an apparatus for processing packets according to a second embodiment of the invention.

FIG. 3 is a table depicting various packet processing flows according to different interface configurations of the apparatus shown in FIG. 2.

FIG. 4 depicts packets being processed according to the various packet processing flows shown in FIG. 3.

FIG. 5 depicts a method of processing packets according to a third embodiment of the invention.

FIG. 6 depicts in greater detail a step in the method depicted in FIG. 5.

In the figures like features are denoted by like reference characters.

### DETAILED DESCRIPTION

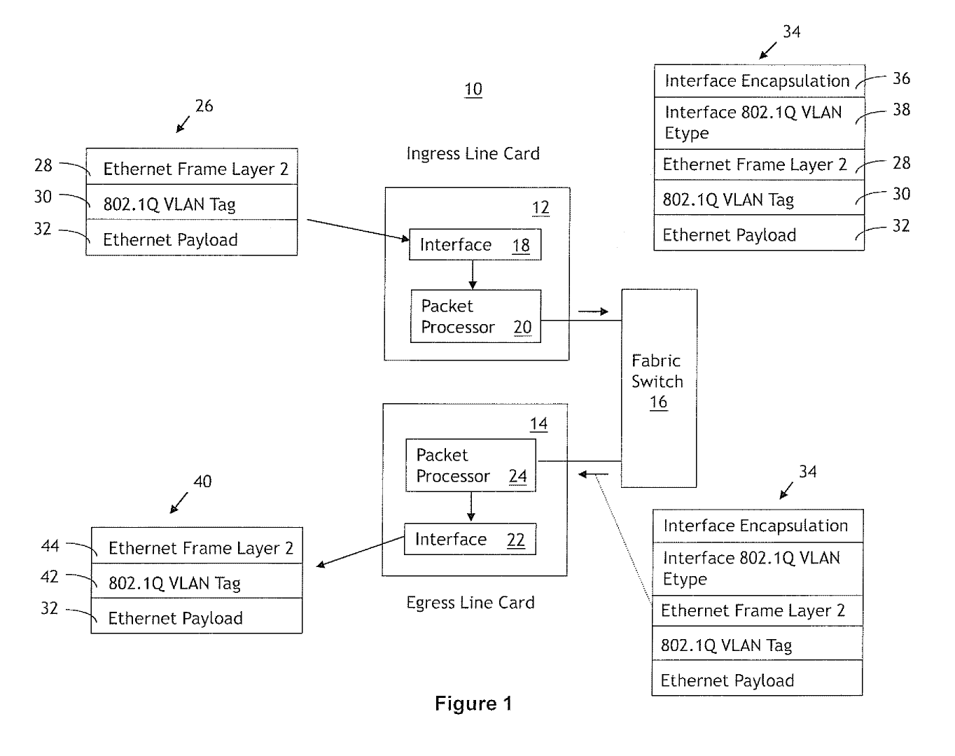

FIG. 1 depicts an apparatus 10 for processing Ethernet VLAN traffic in a system such as a switch or router having distributed router architecture. The apparatus 10 includes an ingress line card 12 and an egress line card 14 both coupled to a fabric switch 16 for switching Ethernet packets between the line cards 12, 14. Typically the ingress and egress line cards 12, 14 would be similar in that a given line card 12, 14 could both receive ingress Ethernet traffic and transmit egress Ethernet traffic.

The ingress line card 12 has an ingress interface 18 configured to receive Ethernet traffic and a packet processor 20 for performing packet processing operations on ingress Ethernet frames such as an ingress frame 26 having an Ethernet Frame Layer 2 (L2) header 28, an 802.1Q VLAN tag 30, and an Ethernet payload 32. The packet processor 20 could be implemented as a device such as a network processor, a field programmable gate array (FPGA), an application specific integrated circuit (ASIC), a microprocessor adapted for packet processing via program instructions, or any combination thereof.

Similarly the egress line card 14 includes an egress interface 22 configured to transmit Ethernet traffic and a packet processor 24 for performing packet processing operations on egress Ethernet frames such as an egress frame 40 having an Ethernet Frame Layer 2 (L2) header 44, an 802.1Q VLAN tag 42, and the Ethernet payload 32. The packet processor 24 could be implemented as a device such as a network processor, a field programmable gate array (FPGA), an application specific integrated circuit (ASIC), a microprocessor adapted for packet processing via program instructions, or any combination thereof.

The packet processor 20 at the ingress line card 12 receives the Ethernet frame 26, creates and adds an internal header (IH) to form an Ethernet frame with an internal header 34. The internal header includes an interface encapsulation information 36 and interface Ethernet frame type information 38. The packet processor 12 then sends the Ethernet frame with an internal header 34 to the fabric switch 16. The fabric switch 16 switches the Ethernet frame with an internal header 34 to the egress line card 14. The packet processor 24 at the egress line card 14 receives the Ethernet frame with an internal header 34, removes the internal header and performs packet processing operations on the Ethernet frame, such as in this case swapping the 802.1Q VLAN tag 30 with the 802.1Q VLAN tag 42. The specific packet processing operations performed by the packet processor 24 of the egress line card 14 for any given Ethernet frame are dependent on the configuration of the egress interface 22 and the internal header. For certain types of Ethernet frames (as in this example) the packet processor 24 makes use of the Ethernet frame type information 38 in the internal header to parse the Ethernet frame.

The apparatus 10 performs 802.1Q VLAN tag manipulation on an Ethernet frame 26 only once in the router or switch using ingress interface 18 and egress interface 22 configuration information. When the Ethernet frame 26 is received by the ingress interface 18, ingress interface encapsulation parsing information is propagated with the frame 26 by adding internal header on a per packet basis. The 802.1Q VLAN tag manipulation is performed only at the egress line card 14 based on the internal header and the egress interface 22 configuration.

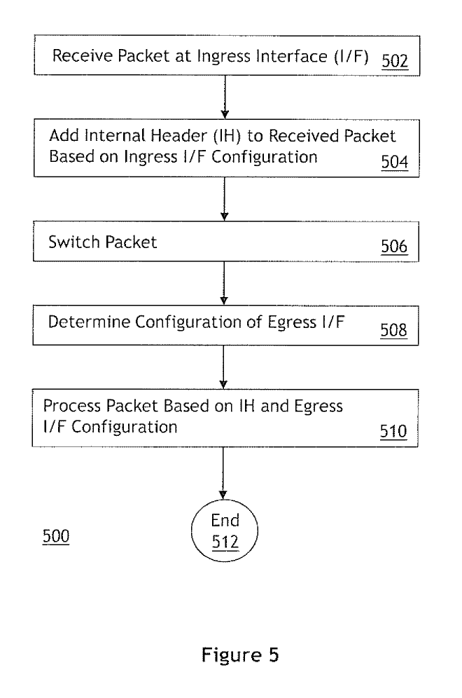

When the Ethernet frame 26 is received over the ingress interface 18, source interface encapsulation 36 e.g. NULL or 802.1Q and the 802.1Q VLAN tag Ether type 38 of the frame 26 is propagated in the internal header being added in front of the original frame 26. When the Ethernet frame with the internal header 34 is received at the egress line card 14, then 802.1Q VLAN tag manipulation is performed according to the method shown in FIG. 5. The method uses source interface encapsulation 36 propagated in the internal header to determine which VLAN tag manipulation action (e.g. SWAP, PUSH or POP 802.1Q VLAN tag) is required. The method also uses 802.1Q VLAN Etype 38 propagated in the internal header to parse the original frame 26.

For example: when an Ethernet frame 26 is received over an ingress interface 18 configured with 802.1Q encapsulation, internal header is marked with interface 802.1Q encapsulation, and 802.1Q VLAN Etype. Before this Ethernet frame 26 leaves the egress interface 22 configured with 802.1Q VLAN encapsulation, the egress packet processor 24 will swap the 802.1Q VLAN tag and 802.1Q Etype with the one configured on the egress interface 22.

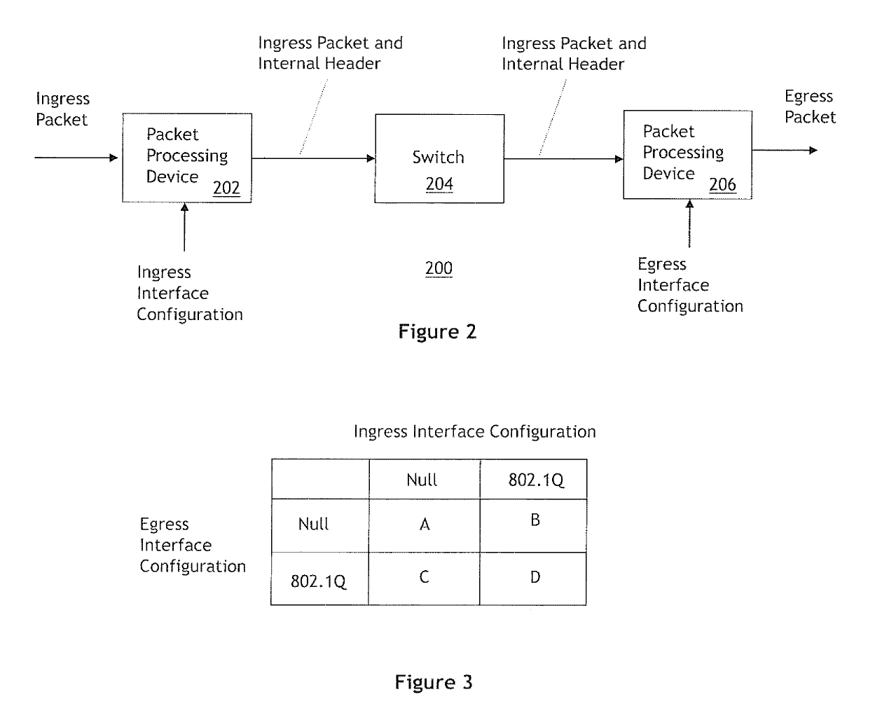

FIG. 2 depicts an apparatus 200 for processing packets according to an embodiment. The apparatus 200 includes an ingress device 202 having access to ingress configuration for receiving ingress packets. The ingress device 202 is operable to receive an ingress packet and to append to the packet an internal header corresponding to the ingress configuration. The apparatus 200 also includes an egress device 206 having access to egress configuration for transmitting egress packets. The apparatus 200 further includes a switch 204 coupled to the ingress device 202 and the egress device 206. The switch 204 is operable to receive from the ingress device 202 and transmit to the egress device 206 the ingress packet with the appended internal header. Furthermore the egress device 206 is operable to process the ingress packet based on the internal header and the egress configuration to form an egress packet.

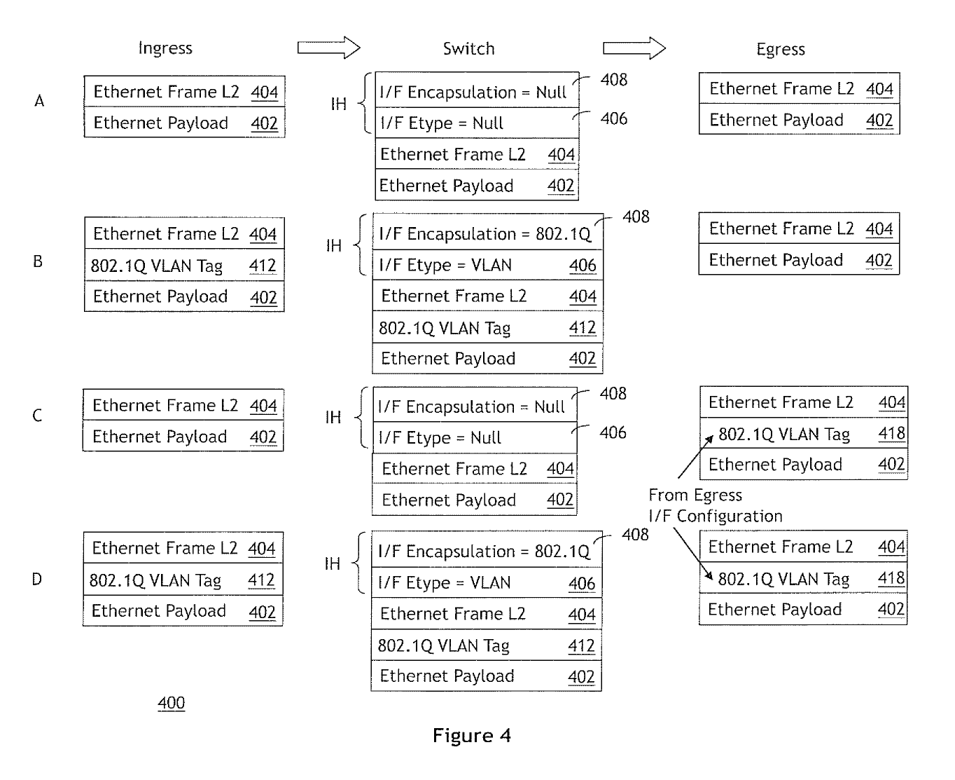

FIG. 3 is a table depicting various packet processing flows according to different interface configurations of the apparatus shown in FIG. 2. There are two columns in the table; one for an ingress interface configuration corresponding to 802.1Q encapsulation on ingress packets and another for no encapsulation (Null) on ingress packets received at the ingress device 202. There are two rows in the table; one for an egress interface configuration corresponding to 802.1Q encapsulation on egress packets and another for no encapsulation (Null) on egress packets transmitted by the egress device 206. Flow packet processing flow identifiers A, B, C, D are assigned for convenience of explaining packet processing operations in a proceeding description of FIG. 4. When both ingress and egress interface configurations are null the packet processing flow corresponds to the identifier A. When the ingress interface configuration is 802.1Q and the egress interface configuration is null the packet processing flow corresponds to the identifier B. When the ingress interface configuration is null and the egress interface configuration is 802.1Q the packet processing flow corresponds to the identifier C. When both ingress and egress interface configurations are 802.1Q the packet processing flow corresponds to the identifier D.

FIG. 4 depicts packets being processed 400 according to the various packet processing flows shown in FIG. 3. In a first packet processing flow corresponding to the identifier A, an ingress packet received at the ingress device 202 has an Ethernet payload 402 and an Ethernet Frame L2 header 404. The ingress device 202 appends an internal header (IH) to the ingress packet based on the ingress configuration. The IH has a first field 406 that indicates ingress interface Ethernet frame type (Etype) and a second field 408 that indicates ingress interface encapsulation. In this case both the first and second fields 406, 408 of the IH are set to null. The ingress device 202 sends the packet with the appended IH to the switch 204, which switches the packet with the appended IH to the egress device 206. The egress device 206 removes the IH to form an egress packet comprising the Ethernet payload 402 and the Ethernet Frame L2 header 404. The egress packet is compliant with the egress interface configuration of null.

In a second packet processing flow corresponding to the identifier B, an ingress packet received at the ingress device 202 includes the Ethernet payload 402, the Ethernet Frame L2 header 404, and an 802.1Q VLAN tag 412. The ingress device 202 appends an internal header (IH) to the ingress packet based on the ingress configuration. The first field 406 indicates ingress interface Etype as being VLAN and the second field 408 indicates ingress interface encapsulation as being 802.1Q. The ingress device 202 sends the packet with the appended IH to the switch 204, which switches the packet with the appended IH to the egress device 206. The egress device 206 removes the IH and the 802.1Q VLAN tag 412 to form an egress packet comprising the Ethernet payload 402 and the Ethernet Frame L2 header 404. The egress packet is compliant with the egress interface configuration of null.

In a third packet processing flow corresponding to the identifier C, an ingress packet received at the ingress device 202 includes the Ethernet payload 402 and the Ethernet Frame L2 header 404. The ingress device 202 appends an internal header (IH) to the ingress packet based on the ingress configuration. The first field 406 indicates ingress interface Etype as being null and the second field 408 indicates ingress interface encapsulation as being null. The ingress device 202 sends the packet with the appended IH to the switch 204, which switches the packet with the appended IH to the egress device 206. The egress device 206 removes the IH and inserts an 802.1Q VLAN tag 418, in accordance with the egress interface configuration, to form an egress packet. The egress packet comprises the Ethernet payload 402, the Ethernet Frame L2 header 404 and the 802.1Q VLAN tag 418. The egress packet is compliant with the egress interface configuration of 802.1Q.

In a fourth packet processing flow corresponding to the identifier D, an ingress packet received at the ingress device 202 includes the Ethernet payload 402, the Ethernet Frame L2 header 404, and the 802.1Q VLAN tag 412. The ingress device 202 appends an internal header (IH) to the ingress packet based on the ingress configuration. The first field 406 indicates ingress interface Etype as being VLAN and the second field 408 indicates ingress interface encapsulation as being 802.1Q. The ingress device 202 sends the packet with the appended IH to the switch 204, which switches the packet with the appended IH to the egress device 206. The egress device 206 removes the IH and replaces the 802.1Q VLAN tag 412 with the 802.1Q VLAN tag 418 to form an egress packet. The egress packet comprises the Ethernet payload 402, the Ethernet Frame L2 header 404 and the 802.1Q VLAN tag 418. The egress packet is compliant with the egress interface configuration of 802.1Q.

FIG. 5 depicts a method 500 of processing packets according to an embodiment. The method 500 starts with receiving 502 a packet at an ingress interface of a line card in the system. A packet processing device of the line card adds 504 an internal header to the packet. The internal header corresponds to configuration of the ingress interface (e.g. 802.1Q encapsulation or none). The packet with the internal header is then switched 506 by a switch fabric to a device of the system. The device, e.g. a packet processing device, could be on another line card of the system or in some cases the device could be on the same line card. The device then determines 508 a configuration of an egress interface associated with the device, and processes 510 the packet based on the internal header and the configuration of the egress interface, after which the method 500 ends 512.

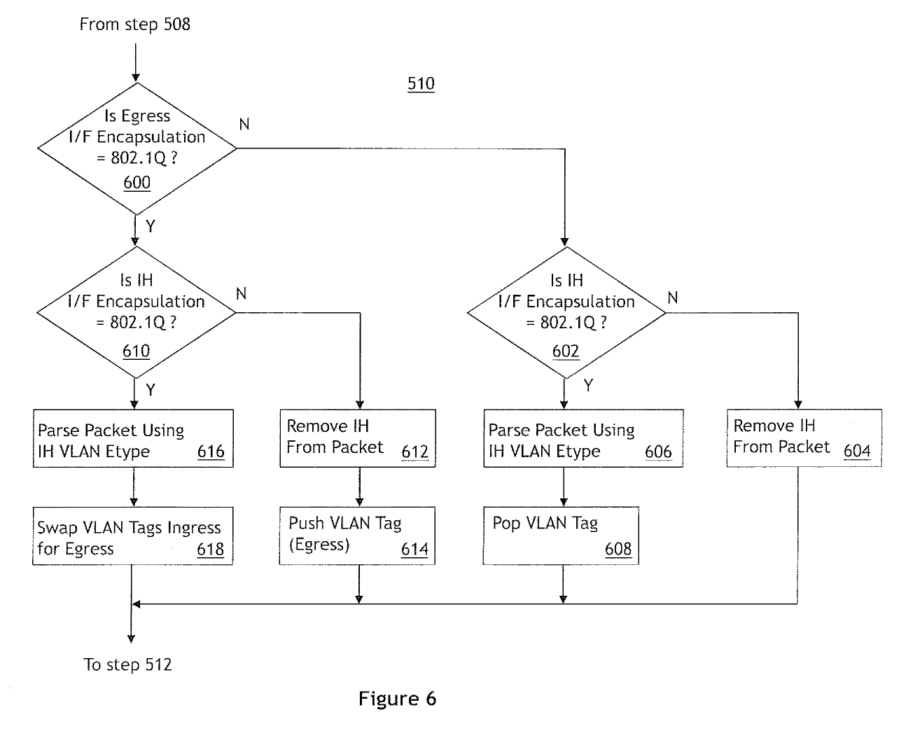

FIG. 6 depicts in greater detail the step of processing 510 the packet. The processing 510 starts with determining 600 if the configuration of the egress interface is 802.1Q. Under either result of this determination 600 the processing 510 then proceeds by determining 602, 610 from the internal header if the configuration of the ingress interface is 802.1Q. If the configuration of the egress interface and the configuration of the ingress interface are not 802.1Q, processing 510 continues by removing 604 the internal header from the packet to form an egress packet.

If the configuration of the egress interface is not 802.1Q and the configuration of the ingress interface is 802.1Q, the processing 510 proceeds by parsing 606 the packet based on VLAN Etype frame type indicated by the internal header. Parsing 606 includes removing the internal header from the packet. The processing 510 also includes removing (pop) 608 a first tag (e.g. 802.1Q VLAN tag) from the packet to form an egress packet.

If the configuration of the egress interface is 802.1Q and the configuration of the ingress interface is not 802.1Q, as determined 610, the processing 510 proceeds by removing 612 the internal header from the packet. The processing 510 continues by inserting (push) 614 into the packet a second tag (e.g. 802.1Q VLAN tag) corresponding to the configuration of the egress interface to form an egress packet.

If the configuration of the egress interface and the configuration of the ingress interface are 802.1Q, the processing 510 proceeds by parsing 616 the packet based on the VLAN Etype frame type indicated by the internal header. Parsing 616 includes removing the internal header from the packet. The processing 510 continues by removing the first tag (e.g. 802.1Q VLAN tag) from the packet and inserting the second tag (e.g. 802.1Q VLAN tag) into the packet to form an egress packet. The actions of removing the first tag and inserting the second tag are referred to as swapping 618 the ingress VLAN tag for the egress VLAN tag.

Advantageously, embodiments run Ethernet 802.1Q VLAN tag manipulation operations only on an egress packet processing device and therefore somewhat free up ingress packet processing resources. Further advantageously, embodiments that do not change the Ethernet 802.1Q VLAN priority when Ethernet 802.1Q VLAN tag is being swapped (e.g. 802.1Q VLAN tagged packet is received on an 802.1Q VLAN encapsulated port and leaves on an interface that is 802.1Q VLAN encapsulated) provide an additional option of keeping the original 802.1Q VLAN priority received on the packet.

Numerous modifications, variations and adaptations may be made to the embodiments of the invention described above without departing from the scope of the invention, which is defined in the claims.

What is claimed is:

1. A method of processing a packet in a system, comprising the steps of:
receiving the packet at an ingress interface of the system;
adding an internal header to the packet, the internal header corresponding to a configuration of the ingress interface;
switching the packet with the internal header to a device of the system;
determining a configuration of an egress interface associated with the device; and
processing the packet based on the internal header and the configuration of the egress interface.

2. The method of claim 1 wherein the step of processing the packet comprises:
determining if the configuration of the egress interface is of a first type;
determining, from the internal header, if the configuration of the ingress interface is of the first type; and
removing the internal header from the packet responsive to the configuration of the egress interface and the configuration of the ingress interface not being of the first type.

3. The method of claim 2 wherein the step of processing the packet further comprises:
performing the following steps responsive to the configuration of the egress interface not being of the first type and the configuration of the ingress interface being of the first type:
parsing the packet based on a frame type indicated by the internal header,
removing the internal header from the packet, and
removing a first tag from the packet.

4. The method of claim 3 wherein the step of processing the packet further comprises:
performing the following steps responsive to the configuration of the egress interface being of the first type and the configuration of the ingress interface not being of the first type:
removing the internal header from the packet, and
inserting into the packet a second tag corresponding to the configuration of the egress interface.

5. The method of claim 4 wherein the step of processing the packet further comprises:
performing the following steps responsive to the configuration of the egress interface and the configuration of the ingress interface being of the first type:
parsing the packet based on a frame type indicated by the internal header,
removing the first tag from the packet, and
inserting the second tag into the packet.

6. The method of claim 1 wherein the packet is an Ethernet packet.

7. The method of claim 3 wherein the first tag is a Virtual Local Area Network (VLAN) tag.

8. The method of claim 4 wherein the second tag is a VLAN tag.

9. The method of claim 2 wherein the first type is 802.1Q VLAN encapsulation.

10. An apparatus for processing a packet comprising:
an ingress device having access to ingress configuration for receiving packets and being operable to receive the packet and add thereto an internal header corresponding to the ingress configuration;
an egress device having access to egress configuration for transmitting packets; and
a switch operable to receive from the ingress device and transmit to the egress device the packet with the internal header,
wherein the egress device is operable to process the packet based on the internal header and the egress configuration.

11. The apparatus of claim 10 wherein the egress device is further operable to process the packet by:
determining if the egress configuration is of a first type;
determining, from the internal header, if the ingress configuration is of the first type; and
removing the internal header from the packet responsive to the egress configuration and the ingress configuration not being of the first type.

12. The apparatus of claim 11 wherein the egress device is further operable to process the packet by performing the following steps responsive to the egress configuration not being of the first type and the ingress configuration being of the first type:
parsing the packet based on a frame type indicated by the internal header,
removing the internal header from the packet, and
removing a first tag from the packet.

13. The apparatus of claim 12 wherein the egress device is further operable to process the packet by performing the following steps responsive to the egress configuration being of the first type and the ingress configuration not being of the first type:
removing the internal header from the packet, and
inserting into the packet a second tag corresponding to the egress configuration.

14. The apparatus of claim 13 wherein the egress device is further operable to process the packet by performing the following steps responsive to the egress configuration and the ingress configuration being of the first type:
parsing the packet based on a frame type indicated by the internal header,
removing the first tag from the packet, and
inserting the second tag into the packet.

15. The apparatus of claim 10 wherein the packet is an Ethernet packet.

16. The apparatus of claim 12 wherein the first tag is a Virtual Local Area Network (VLAN) tag.

17. The apparatus of claim 13 wherein the second tag is a VLAN tag.

18. The apparatus of claim 11 wherein the first type is 802.1Q VLAN encapsulation.

19. An apparatus for processing an Ethernet packet comprising:
an ingress device having an ingress configuration for receiving packets and being operable to receive the Ethernet packet and add thereto an internal header corresponding to the ingress configuration;
an egress device having an egress configuration for transmitting packets; and
a switch operable to receive from the ingress device and transmit to the egress device the Ethernet packet with the internal header,
wherein the egress device is further operable to:
determine from the internal header if the ingress configuration is 802.1Q VLAN encapsulation,
remove the internal header from the Ethernet packet,
remove a first VLAN tag from the Ethernet packet if the egress configuration is not 802.1Q VLAN encapsulation and the ingress configuration is 802.1Q VLAN encapsulation,
insert into the Ethernet packet a second VLAN tag corresponding to the egress configuration if the egress configuration is 802.1Q VLAN encapsulation and the ingress configuration is not 802.1Q VLAN encapsulation, and
remove the first VLAN tag from the Ethernet packet and insert the second VLAN tag into the Ethernet packet if the egress configuration and the ingress configuration are 802.1Q VLAN encapsulation.

20. A method of processing an Ethernet packet in a system, comprising the steps of:
receiving the Ethernet packet at an ingress interface of the system;
adding an internal header to the Ethernet packet, the internal header corresponding to an ingress configuration of the ingress interface;
switching the Ethernet packet with the internal header to a device of the system;
determining an egress configuration of an egress interface associated with the device;
determining from the internal header if the ingress configuration is of a first type;
removing the internal header from the Ethernet packet;
removing a first VLAN tag from the Ethernet packet if the egress configuration is not of the first type and the ingress configuration is of the first type;
inserting into the Ethernet packet a second VLAN tag corresponding to the egress configuration if the egress configuration is of the first type and the ingress configuration is not of the first type; and
removing the first VLAN tag from the Ethernet packet and inserting the second VLAN tag into the Ethernet packet if the egress configuration and the ingress configuration are of the first type.
